(19) United States
(12) Patent Application Publication
(10) Pub. No.: US 2014/0045973 A1
(43) Pub. Date: Feb. 13, 2014

(54) TRIMETHYL BORATE IN EPOXY RESINS

(71) Applicants: Ashwin R. Bharadwaj, Pearland, TX (US); William E. Mercer, II, Clute, TX (US); Lameck Banda, Manvel, TX (US); Michael J. Mullins, Houston, TX (US)

(72) Inventors: Ashwin R. Bharadwaj, Pearland, TX (US); William E. Mercer, II, Clute, TX (US); Lameck Banda, Manvel, TX (US); Michael J. Mullins, Houston, TX (US)

(73) Assignee: DOW GLOBAL TECHNOLOGIES LLC, Midland, MI (US)

(21) Appl. No.: 14/006,706

(22) PCT Filed: May 1, 2012
(86) PCT No.: PCT/US12/35926

§ 371 Date: Sep. 23, 2013

Related U.S. Application Data
(60) Provisional application No. 61/481,283, filed on May 2, 2011.

(51) Int. Cl. C09D 163/00

(52) U.S. Cl. CPC C09D 163/00
USPC 523/400

(57) ABSTRACT

A composition comprising a polyepoxide, a hardener, trimethyl borate, and a flame retardant is disclosed. Methods for preparing the composition and its end uses are also disclosed.

### REFERENCE TO RELATED APPLICATIONS

This application is a non-provisional application claiming priority from the U.S. Provisional Patent Application No. 61/481,283, filed on May 2, 2011, entitled “TRIMETHYL BORATE IN EPOXY RESINS” the teachings of which are incorporated by reference herein, as if reproduced in full hereinbelow.

### FIELD OF THE INVENTION

The present invention relates generally to epoxy resins, to processes for the production thereof, and to thermoset products which are made from these resins.

### BACKGROUND OF THE INVENTION

Epoxy resins are widely used in both industrial and consumer electronics because of, among other things, their chemical resistance, mechanical strength and electrical properties. For example, epoxy resins can be used in electronics as protective films, adhesive materials and/or insulating materials, such as interlayer insulating films. To be useful for these applications, the epoxy resins need to provide ease of handling and certain necessary physical, thermal, electrical insulation and moisture resistance properties. For example, epoxy resins having a low dielectric constant, a high solubility and a low moisture uptake as well as a high glass transition temperature (Tg) can be desirable combination of properties for electrical applications.

Frequently, for many products prepared using epoxy resins, several different entities may perform different parts of the manufacturing process. For example, one entity may make the resin, a second entity (a ‘formulator’) may make the resin formulations used to impregnate the reinforcing material, and a third may make a prepreg, or other article to be used, while a fourth would make the final product such as a laminate of printed circuit board. Frequently the entity producing the prepreg or laminate has no expertise or desire to make the formulation. Therefore, it is desirable that the formulator be able to make a composition useful in coating the materials to be laminated. The problem is that if the epoxy resin curing agent and catalyst are preformulated, the formulation may not have significant long term storage stability. Under such circumstances the formulation may undergo curing and therefore not be useful to the prepreg or laminate manufacturer. What is further needed is a composition containing resin, curing agent, and catalyst that can be stored between formulation and use.

### SUMMARY OF THE INVENTION

In an embodiment of the invention, there is provided a composition comprising, consisting of, or consisting essentially of:

a) a polyepoxide;
b) a hardener;
c) a trimethyl borate; and
d) a flame retardant.

### DETAILED DESCRIPTION OF THE INVENTION

In an embodiment of the invention, there is provided a composition comprising, consisting of, or consisting essentially of:

a) a polyepoxide;
b) a hardener;
c) a trimethyl borate; and
d) a flame retardant.

### Polyepoxide

Polyepoxide as used herein refers to a compound containing more than one epoxy moiety. In another embodiment, it refers to a mixture of compounds, which contains, on average, more than one epoxy moiety per molecule. Polyepoxide as used herein includes partially advanced epoxy resins, i.e. the reaction of a polyepoxide and a curing agent, wherein the reaction product has an average of at least one unreacted epoxide unit per molecule.

The epoxy resins used in embodiments disclosed herein may vary and include conventional and commercially available epoxy resins, which may be used alone or in combinations of two or more, including, for example, novolac resins, isocyanate modified epoxy resins, and carboxylate adducts, among others. In choosing epoxy resins for compositions disclosed herein, consideration should not only be given to properties of the final product, but also to viscosity and other properties that may influence the processing of the resin composition.

The epoxy resin component may be any type of epoxy resin useful in molding compositions, including any material containing one or more oxirane groups, referred to herein as “epoxy groups” or “epoxy functionality.” Epoxy resins useful in embodiments disclosed herein may include mono-functional epoxy resins, multi- or poly-functional epoxy resins, and combinations thereof. Monomeric and polymeric epoxy resins may be aliphatic, cycloaliphatic, aromatic, or heterocyclic epoxy resins. The polymeric epoxies include linear polymers having terminal epoxy groups (a diglycidyl ether of a polyoxyalkylene glycol, for example), polymer skeletal oxirane units (polybutadiene polyepoxide, for example) and polymers having pendant epoxy groups (such as a glycidyl methacrylate polymer or copolymer, for example). The epoxies may be pure compounds, but are generally mixtures or compounds containing one, two or more epoxy groups per molecule. In some embodiments, epoxy resins may also include reactive —OH groups, which may react at higher temperatures with anhydrides, organic acids, amino resins, phenolic resins, or with epoxy groups (when catalyzed) to result in additional crosslinking.

In general, the epoxy resins may be glycidyl ethers, cycloaliphatic resins, epoxidized oils, and so forth. Illustrative polyepoxide compounds useful in embodiments disclosed herein are described in the 2^{nd} chapter of “Epoxy Resins” by Clayton A. May, published in 1988 by Marcel Dekker, Inc., New York, and U.S. Pat. No. 4,066,628. The glycidyl ethers are frequently the reaction product of epichlorohydrin and a phenol or polyphenolic compound such as bisphenol A (commercially available as D.E.R.™ 383 or D.E.R.™ 330 from The Dow Chemical Company, Midland, Mich.); pyrocatechol, resorcinol, hydroquinone, 4,4′-dihydroxydiphenyl methane (or bisphenol F), 4,4′-dihydroxy-3,3′-dimethyldiphenyl methane, 2,2-bis-(4,4′-dihydroxydiphenyl) propane (or bisphenol A), 2,2-bis-(4,4′-dihydroxydiphenyl)ethane, 4,4′-dihydroxydiphenyl cyclohexane, 4,4′-dihydroxy-3,3′-dimethyldiphenyl propane, 4,4′-dihydroxydiphenyl sulfone, and tris(4-hydroxyphenyl)methane; chlorinated or brominated products of the above-mentioned diphenols, such as tetrabromobisphenol A. As is well-known in the art, such materials typically contain small amounts of oligomers derived from condensation of the phenolic starting material with the glycidyl ether product. ‘Advanced’ resins are prepared by reacting a polyepoxide with a polyphenol. Such oligomers are useful in the formulation to achieve useful rheology and cure characteristics. Specific examples include the condensation products of bisphenol A diglycidyl ether with bisphenol A, tetrabromobisphenol A or the condensation products of the diglycidyl ether of tetrabromobisphenol A with bisphenol A or tetrabromobisphenol A. In addition, aromatic isocyanates such as methylene diisocyanate or toluene diisocyanate may be added during these advancement reactions to give oligomers that contain oxazolidinone heterocycles in the backbone of the chains. Commercial examples are D.E.R.™ 592 and D.E.R.™ 593, each available from The Dow Chemical Company, Midland Mich. It is common to add the glycidyl ethers of novolacs, which are polyphenols derived from condensation of formaldehyde or other aldehyde with a phenol. Specific examples include the novolacs of phenol, cresol, dimethylphenols, p-hydroxybiphenyl, naphthol, and bromophenols.

Other epoxy resins are derived from epoxidation of olefins, typically with peracids or hydrogen peroxide. The olefins may be contained within a linear or cyclic chain.

In some embodiments, the epoxy resin may include glycidyl ether type; glycidyl-ester type; alicyclic type; heterocyclic type, and halogenated epoxy resins, etc. Non-limiting examples of suitable epoxy resins may include cresol novolac epoxy resin, phenolic novolac epoxy resin, biphenyl epoxy resin, hydroquinone epoxy resin, stilbene epoxy resin, and mixtures and combinations thereof.

Suitable polyepoxy compounds may include resorcinol diglycidyl ether (1,3-bis-(2,3-epoxypropoxy)benzene), diglycidyl ether of bisphenol A (2,2-bis(p-(2,3-epoxypropoxy)phenyl)propane), triglycidyl p-aminophenol (4-(2,3-epoxypropoxy)-N,N-bis(2,3-epoxypropyl)aniline), diglycidyl ether of bromobisphenol A (2,2-bis(4-(2,3-epoxypropoxy)-3-bromo-phenyl)propane), diglycidyl ether of bisphenol F (2,2-bis(p-(2,3-epoxypropoxy)phenyl)methane), triglycidyl ether of meta- and/or para-aminophenol (3-(2,3-epoxypropoxy)N,N-bis(2,3-epoxypropyl)aniline), and tetraglycidyl methylene dianiline (N,N,N′,N′-tetra(2,3-epoxypropyl) 4,4′-diaminodiphenyl methane), and mixtures of two or more polyepoxy compounds

Useful epoxy resins include, for example, polyglycidyl ethers of polyhydric polyols, such as ethylene glycol, triethylene glycol, 1,2-propylene glycol, 1,5-pentanediol, 1,2,6-hexanetriol, glycerol, and 2,2-bis(4-hydroxy cyclohexyl)propane; polyglycidyl ethers of aliphatic and aromatic polycarboxylic acids, such as, for example, oxalic acid, succinic acid, glutaric acid, terephthalic acid, 2,6-napthalene dicarboxylic acid, and dimerized linoleic acid; polyglycidyl ethers of polyphenols, such as, for example, bis-phenol A, bis-phenol F, 1,1-bis(4-hydroxyphenyl)ethane, 1,1-bis(4-hydroxyphenyl)isobutane, and 1,5-dihydroxy naphthalene; modified epoxy resins with acrylate or urethane moieties; glycidylamine epoxy resins; and novolac resins.

Further epoxy-containing materials which are particularly useful include those based on glycidyl ether monomers. Examples are di- or polyglycidyl ethers of polyhydric phenols obtained by reacting a polyhydric phenol with an excess of chlorohydrin such as epichlorohydrin. Such polyhydric phenols include resorcinol, bis(4-hydroxyphenyl)methane (known as bisphenol F), 2,2-bis(4-hydroxyphenyl)propane (known as bisphenol A), 2,2-bis(4′-hydroxy-3′,5′-dibromophenyl)propane, 1,1,2,2-tetrakis(4′-hydroxy-phenyl)ethane or condensates of phenols with formaldehyde that are obtained under acid conditions such as phenol novolacs and cresol novolacs. Examples of this type of epoxy resin are described in U.S. Pat. No. 3,018,262. Other examples include di- or polyglycidyl ethers of polyhydric alcohols such as 1,4-butanediol, or polyalkylene glycols such as polypropylene glycol and di- or polyglycidyl ethers of cycloaliphatic polyols such as 2,2-bis(4-hydroxycyclohexyl)propane. Other examples are monofunctional resins such as cresyl glycidyl ether or butyl glycidyl ether.

Epoxy compounds that are readily available include octadecylene oxide; glycidylmethacrylate; diglycidyl ether of bisphenol A; D.E.R.™ 331 (bisphenol A liquid epoxy resin) and D.E.R.™ 332 (diglycidyl ether of bisphenol A) available from The Dow Chemical Company, Midland, Mich.; vinylcyclohexene dioxide; 3,4-epoxycyclohexylmethyl-3,4-epoxycyclohexane carboxylate; 3,4-epoxy-6-methylcyclohexyl-methyl-3,4-epoxy-6-methylcyclohexane carboxylate; bis(3,4-epoxy-6-methylcyclohexylmethyl) adipate; bis(2,3-epoxycyclopentyl)ether; aliphatic epoxy modified with polypropylene glycol; dipentene dioxide; epoxidized polybutadiene; silicone resin containing epoxy functionality; flame retardant epoxy resins (such as a brominated epoxy resin available under the tradename D.E.R.™ 592 or a brominated bisphenol type epoxy resin available under the tradename D.E.R.™ 560, available from The Dow Chemical Company, Midland, Mich.); 1,4-butanediol diglycidyl ether, polyglycidyl ether of phenol formaldehyde novolac (such as those available under the tradenames D.E.N.™ 431 and D.E.N.™ 438 available from The Dow Chemical Company, Midland, Mich.); and resorcinol diglycidyl ether. Although not specifically mentioned, other epoxy resins under the trade name designations D.E.R.™ and D.E.N.™ available from The Dow Chemical Company may also be used.

Another example of a polyepoxide is the condensation product of an epoxy novolac with DOPO (6H-dibenz[c,e][1,2]oxaphosphorin, 6-oxide). Mixtures of any of the above-listed epoxy resins may, of course, also be used.

### Hardener

The inventive composition also contains a hardener, also known as a curing agent.

In an embodiment, the hardener contains amine or amide groups.

In an embodiment, the hardener of the present invention includes at least one phenolic hydroxyl functionality, a compound capable of generating at least one phenolic hydroxyl functionality, or mixtures thereof.

Examples of compounds with a phenolic hydroxyl functionality include compounds having an average of one or more phenolic groups per molecule. Suitable phenol hardeners include but are not limited to dihydroxy phenols, biphenols, bisphenols, halogenated biphenols, halogenated bisphenols, alkylated biphenols, alkylated bisphenols, trisphenols, phenol-aldehyde resins, phenol-aldehyde novolac resins, halogenated phenol-aldehyde novolac resins, substituted phenol-aldehyde novolac resins, phenol-hydrocarbon resins, substituted phenol-hydrocarbon resins, phenol-hydroxybenzaldehyde resins, alkylated phenol-hydroxy-benzaldehyde resins, hydrocarbon-phenol resins, hydrocarbon-halogenated phenol resins, hydrocarbon-alkylated phenol resins, and combinations thereof. In an embodiment, the hardener includes substituted or unsubstituted phenols, biphenols, bisphenols, novolacs, and combinations thereof. Examples include phenol novolac, bisphenol A novolac, bisphenol A, tetrabromobisphenol A, and mixtures thereof.

Hardeners in the present invention can be compounds that contain on average more than one active hydrogen atom, wherein the active hydrogen atoms are bonded to the same nitrogen atom or to different nitrogen atoms. Examples of suitable hardeners include: compounds that contain two or more primary or secondary amine or amide moieties linked to a common central organic moiety. Examples of suitable amine-containing hardeners include: diethylene triamine, triethylene tetramine, dicyandiamide, melamine, pyridine, cyclohexylamine, benzyldimethylamine, benzylamine, diethylaniline, triethanolamine, piperidine, N,N-diethyl-1,3-propane diamine, and the like, and soluble adducts of amines and polyepoxudes and their salts.

Polyamides are preferably the reaction product of a polyacid and an amine. Examples of polyacids used in making these polyamides include, among others, 1,10-decanedioic acid, 1,12-dodecanedienedioic acid, 1,20-eicosadienedioic acid, 1,14-tetradecanedioic acid, 1,18-octadecanedioic acid and dimerized and trimerized fatty acids. Amines used in making the polyamides include preferably the aliphatic and cycloaliphatic polyamines as ethylene diamine, diethylene triamine, triethylene tetramine, tetraethylene pentamine, 1,4-diamino-butane, 1,3-diaminobutane, hexamethylene diamine, 3-(N-isopropylamino)propylamine and the like. Especially preferred polyamides are those derived from the aliphatic polyamides containing no more than 12 carbon atoms and polymeric fatty acids obtained by dimerizing and/or trimerizing ethylenically unsaturated fatty acids containing up to 25 carbon atoms. These preferred polyamides preferably have a viscosity between 10 and 750 poises at 40° C. Preferred polyamides also have amine values of 50 to 450.

In an embodiment, hardeners are aliphatic polyamines, polyglycoldiamines, polyoxypropylene diamines, polyoxypropylenetriamines, amidoamines, imidazolines, reactive polyamides, ketimines, araliphatic polyamines (i.e. xylylenediamine), cycloaliphatic amines (i.e. isphoronediamine or diaminocyclohexane) menthane diamine, 3,3-dimethyl-4,4-diamino-dicyclohexylmethane, heterocyclic amines (aminoethyl piperazine), aromatic polyamines (methylene dianiline), diamino diphenyl sulfone, mannich base, phenalkamine, N,N′,N″-tris(6-aminohexyl) melamine, and the like. The most preferred curing agents are cyanamide, dicyandiamide, and its derivatives, diaminodiphenyl sulfone and methylene dianiline. The ratio of hardener to epoxy resin is suitable to provide a fully cured resn.

The amount of hardener which may be present may vary depending upon the particular curing agent used. The curable composition preferably contains from about 0 to about 150 parts of hardener per hundred parts of resin (phr), more preferably from about 0.5 to about 30 phr hardener, and in yet another embodiment from 1.0 to 10.0 phr hardener, and most preferably from 2 to 4 phr hardener. The equivalent ratio of epoxy moieties to hardener moieties is generally at least about 0.8:1 and in another embodiment at least 0.9:1. The equivalent ratio is preferably no more than about 1.5:1 and more preferably no more than about 1.2:1.

### Catalyst

Optionally, catalysts can be added to the compositions described above. Catalysts can include, but are not limited to, imidazole compounds including compounds having one imidazole ring per molecule, such as imidazole, 2-methylimidazole, 2-ethyl-4-methylimidazole, 2-undecylimidazole, 2-heptadecylimidazole, 2-phenylimidazole, 2-phenyl-4-methylimidazole, 1-benzyl-2-methylimidazole, 2-ethylimidazole, 2-isopropylimidazole, 2-phenyl-4-benzylimidazole, 1-cyanoethyl-2-methylimidazole, 1-cyanoethyl-2-ethyl-4-methylimidazole, 1-cyanoethyl-2-undecylimidazole, 1-cyanoethyl-2-isopropylimidazole, 1-cyanoethyl-2-phenylimidazole, 2,4-diamino-6-[2′-methylimidazolyl-(1)′]-ethyl-s-triazine, 2,4-diamino-6-[2′-ethyl-4-methylimidazolyl-(1)′]-ethyl-s-triazine, 2,4-diamino-6-[2′-undecylimidazolyl-(1)]-ethyl-s-triazine, 2-methyl-imidazo-lium-isocyanuric acid adduct, 2-phenylimidazolium-isocyanuric acid adduct, 1-aminoethyl-2-methylimidazole, 2-phenyl-4,5-dihydroxymethylimidazole, 2-phenyl-4-methyl-5-hydroxymethylimidazole, 2-phenyl-4-benzyl-5-hydroxymethylimidazole and the like; and compounds containing 2 or more imidazole rings per molecule which are obtained by dehydrating above-named hydroxymethyl-containing imidazole compounds such as 2-phenyl-4,5-dihydroxymethylimidazole, 2-phenyl-4-methyl-5-hydroxymethylimidazole and 2-phenyl-4-benzyl-5-hydroxy-methylimidazole; and condensing them with formaldehyde, e.g., 4,4′-methylene-bis-(2-ethyl-5-methylimidazole), and the like. The composition can also contain metal catalysts conventionally used to cure cyanates: zinc naphthenate, zinc octoate, zinc ethylhexoate, zinc hexoate, as well as the manganese, copper, and other transition element (Groups 4-13) of these same anions.

### Inhibitor

The composition contains a trialkyl borate, a Lewis acid curing inhibitor, which forms a complex with the catalyst. In an embodiment, the trialkyl borate is trimethyl borate. The complexes exist in equilibrium with the uncomplexed catalyst and complexing agent. At any given moment a portion of the catalyst is complexed with the complexing agent and a portion is not. The portion of free catalyst is dependent upon several variables, including the complexing agent, its concentration relative to the catalyst, and the temperature of the mixture.

The inhibitor and its concentration are selected such that the resin does not gel too fast at temperatures that are ordinarily used to impregnate and laminate a composite. The stroke cure gel time of the resin containing the inhibitor at about 171° C. is preferably at least about 50 percent longer than the gel time of a similar composition containing no inhibitor. The stroke cure gel time is preferably at least about 100 percent longer, and more preferably at least about 200 percent longer. At about 171° C., the stroke cure gel time of the composition is preferably more than 70 seconds, highly preferably more than 100 seconds, more preferably more than 200 seconds, more highly preferably more than 250 seconds, and most preferably more than 300 seconds. It is desirable to keep the gel time as long as possible, but it is seldom more than about 1000 seconds for useful compositions. The composition preferably exhibits no significant change in its gel time when stored at about 20° C. to 25° C. or less over a period of at least 2 days, more preferably at least about 10 days and most preferably at least about 30 days.

The inhibitor should also dissociate from the catalyst at curing temperatures, so that the excess catalyst causes more rapid curing than compositions with an ordinary catalyst content and no inhibitor. A sample is considered cured when its glass transition temperature changes by no more than 3° C. between first and second testing by the IPC test method 650 2.4.25. The test establishes that under curing conditions there is at least as much catalyst activity as—and preferably more catalyst activity than—a system with ordinary catalyst loadings and no inhibitor. The composition should be cured in no more than about 60 minutes at temperatures of about 175° C. The composition is more preferably cured in no more than about 50 minutes, more preferably in no more than about 30 minutes, and most preferably in no more than about 20 minutes.

The molar ratio of catalyst to inhibitor is selected to provide the results previously described. The optimum ratio may vary from catalyst to catalyst and from inhibitor to inhibitor. In most cases, the molar ratio of inhibitor to catalyst is at least about 0.6:1, more preferably at least about 0.75:1 and most preferably at least about 1:1. The molar ratio of inhibitor to catalyst is generally no more than about 3:1, more preferably no more than about 1.4:1 and most preferably no more than about 1.35:1.

The inhibitor and the catalysts may be separately added to the compositions of the invention, or may be added as a complex. The complex is formed by contacting and intimately mixing a solution of the inhibitor with a solution of the catalyst. Such contacting generally is performed at ambient temperature, although other temperatures may be used, for example, temperatures of 0° C. to 100° C., more preferably from 20° C. to 60° C. The time of contacting is that sufficient to complete formation of the complex, and depends of the temperature used, with from 1 to 120 minutes preferred, and 10 to 60 minutes more preferred.

Before becoming a part of the composition, the trialkyl borate inhibitor is not dissolved in a solvent. This prevents adding a solvent to the composition which would have a low flash point and would be a poor solvent for the other components of the composition. This makes the manufacture of the composition more economical.

In an embodiment, with a trimethyl borate inhibitor, the composition can have a solids content in the range of from about 70 weight percent to about 79 weight percent.

### Halogenated Flame Retardant

The composition may also contain a halogenated flame retardant. The halogenated flame retardant, may include brominated flame retardants. Specific examples of brominated additives include brominated polyphenols such as tetrabromobisphenol A (TBBA) and tetrabromobisphenol F and materials derived therefrom: TBBA-diglycidyl ether, reaction products of bisphenol A or TBBA with TBBA-diglycidyl ether, and reaction products of bisphenol A diglycidyl ether with TBBA. Mixtures of one or more of the above described flame retardant additives can also be used.

### Nonhalogenated Flame Retardant

The composition also may contain a non-halogen flame retardant. In an embodiment, the non-halogen flame retardant can be a phosphorus-containing compound. The phosphorus-containing compound can contain some reactive groups such as a phenolic group, an acid group, an amino group, an acid anhydride group, a phosphate group, or a phosphinate group which can react with the epoxy resin or hardener of the composition.

The phosphorus-containing compound can contain on average one or more than one functionality capable of reacting with epoxy groups. Such phosphorus-containing compound generally contains on average 1 to 6 functionalities. In an embodiment, the phosphorus-containing compound contains in the range of from 1 to 5 functionalities, and in another embodiment, it contains in the range of 2 to 5 functionalities capable of reacting with an epoxy resin. Having an average functionality of greater than one is typically advantageous because it gives higher thermoset Tg's.

The phosphorus-containing compound useful in the present invention include for example one or more of the following compounds: P—H functional compounds such as for example HCA, dimethylphosphite, diphenylphosphite, ethylphosphonic acid, diethylphosphinic acid, methyl ethylphosphinic acid, phenyl phosphonic acid, vinyl phosphonic acid, phenolic (HCA-HQ); tris(4-hydroxyphenyl)phosphine oxide, bis(2-hydroxyphenyl)phenylphosphine oxide, bis(2-hydroxyphenyl)phenylphosphinate, tris(2-hydroxy-5-methylphenyl)phosphine oxide, acid anhydride compounds such as M-acid-AH, and amino functional compounds such as for example bis(4-aminophenyl)phenylphosphate, and mixtures thereof. Other suitable compounds are described in EP1268665, herein incorporated by reference.

In an embodiment, a phosphonate compound can be used. Phosphonates that also contain groups capable of reacting with the epoxy resin or the hardener such as polyglycidyl ethers or polyphenols with covalently-bound tricyclic phosphonates are useful. Examples include but are not limited to the various materials derived from DOP (9,10-dihydro-9-oxa-10-phosphaphenanthrene 10-oxide) such as DOP-hydroquinone (10-(2′,5′-dihydroxyphenyl)-9,10-dihydro-9-oxa-10-phosphaphenanthrene 10-oxide), condensation products of DOP with glycidylether derivatives of novolacs, and inorganic flame retardants such as aluminum trihydrate, aluminum hydroxide (Boehmite) and aluminum phosphinite. If inorganic flame retardant fillers are used, silane treated grades are preferred.

In an embodiment, phosphorus-containing compounds disclosed in WO2005118604, herein incorporated by reference, can be used.

Mixtures of one or more of the above described flame retardancy enhancing compounds may also be used.

Embodiments of the present disclosure can also include the use of at least one maleimide resin with the thermosetting monomers of the present disclosure. Examples of suitable maleimide resins include, but are not limited to, those having two maleimide groups derived from maleic anhydride and diamines or polyamines. Suitable maleimide resins include bismaleimides such as 4,4′-diaminodiphenylmethane, among others.

Embodiments of the present disclosure can also include cyanate compounds. Specific examples of cyanate compounds include but are not limited to 2,2-di(cyanatephenyl)propane, di(4-cyanate-3,5-dimethylphenyl)methane, di(4-cyanate-3,5-dimethylphenyl)ethane, and a cyanate and a phenolic novolac cyanate of a copolymer of phenol and dicyclopentadiene, and these compounds can be used individually or in combination. Of these, more preferred is 2,2-di(cyanatephenyl)propane from the viewpoint of obtaining excellent dielectric property and excellent heat resistance, further preferred is a compound containing a mixture of a trimer and a larger oligomer (polymer) having a triazine ring preliminarily formed by self-polymerization, and, from the viewpoint of achieving a good balance of a dielectric constant and a dielectric dissipation factor with heat resistance and prevention of gelation, especially preferred is a compound in which 10 to 90 mol % of 2,2-di(cyanatephenyl)propane forms a trimer and/or a larger oligomer (polymer).

Embodiments of the present disclosure can also include monomeric and oligomeric benzoxazines and polybenzoxazines. Examples include but are not limited to benzoxazine of phenolphthalein, benzoxazine of bisphenol-A, benzoxazine of bisphenol-F, and benzoxazine of phenol novolac. Mixtures of such components described above may also be used.

Embodiments of the present disclosure can also include functional polyphenylene ethers with reactive chain ends as described in US7393904 and US7541421.

Embodiments of the present disclosure also provide for a composition that includes the thermosetting monomer of the present disclosure and at least one thermoplastic polymer. Typical thermoplastic polymers include, but are not limited to, polymers produced from vinyl aromatic monomers and hydrogenated versions thereof, including both diene and aromatic hydrogenated versions, including aromatic hydrogenation, such as styrene-butadiene block copolymers, polystyrene (including high impact polystyrene), acrylonitrile-butadiene-styrene (ABS) copolymers, and styrene-acrylonitrile copolymers (SAN); polycarbonate (PC), ABS/PC compositions, polyethylene, polyethylene terephthalate, polypropylene, polyphenylenoxides (PPO), hydroxy phenoxy ether polymers (PHE), ethylene vinyl alcohol copolymers, ethylene acrylic acid copolymers, polyolefin carbon monoxide interpolymers, chlorinated polyethylene, polyphenylene ether, polyolefins, olefin copolymers, cyclic olefin copolymers, and combinations or blends thereof.

In an additional embodiment, the composition of the present disclosure can include the thermosetting monomer of the present disclosure and at least one reactive and/or non-reactive thermoplastic resin. Examples of such thermoplastic resins include, but are not limited to, polyphenylsulfones, polysulfones, polyethersulfones, polyvinylidene fluoride, polyetherimide, polypthalimide, polybenzimidiazole, acyrlics, phenoxy, and combinations or blends thereof.

For the various embodiments, the thermosetting monomer of the present disclosure can be blended with the thermoplastic resin to form a hybrid crosslink network. Preparation of the compositions of the present disclosure can be accomplished by suitable mixing means known in the art, including dry blending the individual components and subsequently melt mixing, either directly in the extruder used to make the finished article or pre-mixing in a separate extruder. Dry blends of the compositions can also be directly injection molded without pre-melt mixing.

When softened or melted by the application of heat, the composition of the thermosetting monomers of the present disclosure and the thermoplastic resin can be formed or molded using conventional techniques such as compression molding, injection molding, gas assisted injection molding, calendaring, vacuum forming, thermoforming, extrusion and/or blow molding, alone or in combination. The composition of the thermosetting monomers of the present disclosure and the thermoplastic resin may also be formed, spun, or drawn into films, fibers, multi-layer laminates or extruded sheets, or can be compounded with one or more organic or inorganic substances.

Embodiments of the present disclosure also provide for a composition that includes the thermosetting monomer of the present disclosure and at least one of a polyurethane, a polyisocyanate, a benzoxazine ring-containing compound, an unsaturated resin system containing double or triple bonds, and combinations thereof.

The compositions of the present disclosure described above may also optionally make use of at least one catalyst. Examples of suitable curing catalysts include amines, dicyandiamides, substituted guanidines, phenolics, amino, benzoxazines, anhydrides, amido amines, polyamides, phosphines, ammonium, phosphonium, arsonium, sulfonium moieties or mixtures thereof.

Because of their unique combination of properties, the thermosetting monomer and/or compositions that include the thermosetting monomer may be useful in the preparation of various articles of manufacture. Thus, the disclosure also includes prepregs of the above composition as well as shaped articles, reinforced compositions, laminates, electrical laminates, coatings, molded articles, adhesives, composite products as hereinafter described from cured or partially cured thermosetting monomer or compositions that include the thermosetting monomer of the disclosure. In addition, the compositions of the disclosure can be used for various purposes in the form of a dried powder, pellets, a homogeneous mass, impregnated products or/or compounds.

A variety of additional additives may be added to the composition of the present disclosure. Examples of these additional additives include fibrous reinforcement, fillers, pigments, dyestuffs, thickening agents, wetting agents, lubricants, flame-retardants and the like. Suitable fibrous and/or particulate reinforcing materials include silica, alumina trihydrate, aluminum oxide, aluminum hydroxide oxide, metal oxides, nano tubes, glass fibers, quartz fibers, carbon fibers, boron fibers, Kevlar fibers and Teflon fibers, among others. A size range for the fibrous and/or particulate reinforcing materials can include 0.5 nm to 100 μm. For the various embodiments, the fibrous reinforcing materials can come in the form of a mat, cloth or continuous fibers.

The fibrous or reinforcing material is present in the composition in an amount effective to impart increased strength to the composition for the intended purpose, generally from 10 to 70 wt %, usually from 30 to 65 wt %, based on the weight of the total composition. The laminates of the disclosure can optionally include one or more layers of a different material and in electrical laminates this can include one or more layers of a conductive material such as copper or the like. When the resin composition of this disclosure is used for producing molded articles, laminated articles or bonded structures, the curing is desirably effected under pressure.

In a partially cured state, the fibrous reinforcement impregnated with the composition of the present disclosure can be subjected to a relatively mild heat treatment (“B-staged”) to form a “prepreg.” The prepreg can then subjected to elevated temperature and pressure so as to more completely cure the composition to a hard, inflexible state. A plurality of prepregs can be layered and cured to form a laminate having utility in circuit boards.

Embodiments of the compositions may also include at least one of a synergist to help improve the flame extinguishing ability of the cured composition. Examples of such synergists include, but are not limited to, magnesium hydroxide, zinc borate, metallocenes and combinations thereof. In addition, embodiments of the compositions may also include adhesion promoters, such as modified organosilanes (epoxidized, methacryl, amino), acytlacetonates, sulfur containing molecules and combinations thereof. Other additives can include, but are not limited to, wetting and dispersing aids such as modified organosilanes, Byk® 900 series and W 9010 (Byk-Chemie GmbH), modified fluorocarbons and combinations thereof; air release additives such as Byk® A530, Byk® A525, Byk® A555, and Byk® A 560 (Byk-Chemie GmbH); surface modifiers such as slip and gloss additives; mold release agents such as waxes; and other functional additives or prereacted products to improve polymer properties such as isocyanates, isocyanurates, cyanate esters, allyl containing molecules or other ethylenically unsaturated compounds, acrylates and combinations thereof.

### Process for Producing the Composition

Generally, the components of the composition are mixed together. The components can be mixed together in any combination or sub-combination at ambient temperature. Generally mixing of the composition is achieved by either mixing blade or shaker.

### Process for Curing the Composition

Curing of the compositions disclosed herein may require a temperature of at least about 30° C., up to about 250° C., for periods of minutes up to hours, depending on the epoxy resin, hardener, and catalyst, if used. In other embodiments, curing can occur at a temperature of at least 100° C., for periods of minutes up to hours. Post-treatments may be used as well, such post-treatments ordinarily being at temperatures between about 100° C. and 250° C.

In some embodiments, curing can be staged to prevent large exothermic reactions. Staging, for example, includes curing for a period of time at a temperature followed by curing for a period of time at a higher temperature. Staged curing may include two or more curing stages, and may commence at temperatures below about 180° C. in some embodiments, and below about 150° C. in other embodiments.

In some embodiments, curing temperatures can range from a lower limit of 30° C., 40° C., 50° C., 60° C., 70° C., 80° C., 90° C., 100° C., 110° C., 120° C., 130° C., 140° C., 150° C., 160° C., 170° C., or 180° C. to an upper limit of 250° C., 240° C., 230° C., 220° C., 210° C., 200° C., 190° C., 180° C., 170° C., 160° C., where the range may be from any lower limit to any upper limit.

For the various embodiments, a resin sheet can be formed from the thermosetting monomer and/or compositions of the present disclosure. In one embodiment, a plurality of sheets can be bonded together to form a laminated board, where the sheets comprise at least one of the resin sheet. The thermosetting monomer and/or compositions that include the thermosetting monomer can also be used to form a resin clad metal foil. For example, a metal foil, such as a copper foil, can be coated with the thermosetting monomer and/or compositions that include the thermosetting monomer of the present disclosure. The various embodiments also include a multi layer board that can be prepared by coating a laminated substrate with the thermosetting monomer and/or compositions of the present disclosure.

The compositions of this disclosure comprise one or more components which can each be used in any desired form such as solid, solution or dispersion. These components are mixed in the absence of a solvent to form the compositions of this disclosure. For example, the mixing procedure comprises mixing solutions of the thermosetting monomers and one or more of the formulation components or either separately or together in a suitable inert organic solvent, such as for example, ketones such as methyl ethyl ketone, chlorinated hydrocarbons such as methylene chloride, ethers and the like, and homogenizing the resulting mixed solution at room temperature or at an elevated temperature below the boiling point of the solvents to form a composition in the form of a solution. When homogenizing these solutions at room temperature or at an elevated temperature, some reactions may take place between the constituent elements. So long as the resins components are maintained in the state of solution without gelation, such reactions do not particularly affect the operability of the resulting composition in, for example, a bonding, coating, laminating or molding operation.

For the various embodiments, the compositions of the present disclosure can applied to a substrate as a coating or adhesive layer. Alternatively, the thermosetting monomer and/or compositions of the present disclosure can be molded or laminated in the form of powder, pellet or as impregnated in a substrate such as a fibrous reinforcement. The thermosetting monomer and/or compositions of the present disclosure can then be cured by the application of heat.

The heat necessary to provide the proper curing conditions can depend on the proportion of components constituting the composition and the nature of the components employed. In general, the composition of this disclosure may be cured by heating it at a temperature within the range of 0° C. to 300° C., preferably 100° C. to 250° C., although differing according to the presence of a catalyst or curing agent or its amount, or the types of the components in the composition. The time required for heating can be 30 seconds to 10 hours, where the exact time will differ according to whether the resin composition is used as a thin coating or as molded articles of relatively large thickness or as laminates or as matrix resins for fiber reinforced composites, particularly for electrical and electronic applications, e.g., when applied to an electrically nonconductive material and subsequently curing the composition.

In some embodiments, composites can be formed by curing the compositions disclosed herein. In other embodiments, composites may be formed by applying a curable epoxy resin composition to a substrate or a reinforcing material, such as by impregnating or coating the substrate or reinforcing material to form a prepreg, and curing the prepreg under pressure to form the electrical laminate composition.

After the composition has been produced, as described above, it can be disposed on, in, or between the above described substrates, before, during, or after cure of an electrical laminate composition. For example, a composite may be formed by coating a substrate with a curable composition. Coating may be performed by various procedures, including spray coating, curtain flow coating, coating with a roll coater or a gravure coater, brush coating, and dipping or immersion coating.

In various embodiments, the substrate can be monolayer or multi-layer. For example, the substrate may be a composite of two alloys, a multi-layered polymeric article, and a metal-coated polymer, among others, for example. In other various embodiments, one or more layers of the curable composition may be disposed on a substrate. Other multi-layer composites, formed by various combinations of substrate layers and electrical laminate composition layers are also envisaged herein.

In some embodiments, the heating of the composition can be localized, such as to avoid overheating of a temperature-sensitive substrate, for example. In other embodiments, the heating may include heating the substrate and the composition.

### Cured Product Properties

Formulations prepared and cured according to the present invention exhibit significantly higher glass transition temperatures than other polyphenolic resins including phenol novolac and oxaxolidinone modified resins.

### End Use Applications

The curable compositions disclosed herein may be useful in composites containing high strength filaments or fibers such as carbon (graphite), glass, boron, and the like. Composites can contain from about 30% to about 70%, in some embodiments, and from 40% to 70% in other embodiments, of these fibers based on the total volume of the composite.

Fiber reinforced composites, for example, can be formed by hot melt prepregging. The prepregging method is characterized by impregnating bands or fabrics of continuous fiber with a thermosetting composition as described herein in molten form to yield a prepreg, which is laid up and cured to provide a composite of fiber and epoxy resin.

Other processing techniques can be used to form electrical laminate composites containing the compositions disclosed herein. For example, filament winding, solvent prepregging, and pultrusion are typical processing techniques in which the curable composition may be used. Moreover, fibers in the form of bundles can be coated with the curable composition, laid up as by filament winding, and cured to form a composite.

The curable compositions and composites described herein may be useful as adhesives, structural and electrical laminates, coatings, marine coatings, composites, powder coatings, adhesives, castings, structures for the aerospace industry, and as circuit boards and the like for the electronics industry.

In some embodiments, the curable compositions and resulting thermoset resins may be used in composites, castings, coatings, adhesives, or sealants that may be disposed on, in, or between various substrates. In other embodiments, the curable compositions may be applied to a substrate to obtain an epoxy based prepreg. As used herein, the substrates include, for example, glass cloth, a glass fiber, glass paper, paper, and similar substrates of polyethylene and polypropylene. The obtained prepreg can be cut into a desired size. An electrical conductive layer can be formed on the laminate/prepreg with an electrical conductive material. As used herein, suitable electrical conductive materials include electrical conductive metals such as copper, gold, silver, platinum and aluminum. Such electrical laminates may be used, for example, as multi-layer printed circuit boards for electrical or electronics equipment. Laminates made from the maleimide-triazine-epoxy polymer blends are especially useful for the production of HDI (high density interconnect) boards. Examples of HDI boards include those used in cell phones or those used for Interconnect (IC) substrates.

### EXAMPLES

### Analytical Methods

The glass transition temperature (Tg) was measured by DSC using a TA Instruments Model Q2000 DSC. The method used was IPC TM-650 2.4.25.

The thermal decomposition (Td) is the temperature at which 5 wt % of the cured laminate is lost to decomposition products as measured at a ramp rate of 10° C./minute Td by TGA (TA Instruments Model Q5000 TGA) following the IPC test method 650 2.3.40.

The time to delamination at 260° (T-260) is determined by IPC test method 650-2.4.24 by TMA (TA Instruments Model Q400). Additionally, the heating rate of 10° C./min enables determination of coefficient of thermal expansion pre Tg and post Tg to be measured.

The test for the flammability of a laminate (UL-94), is determined by IPC test method 650-2.3.10B using an ATLAS HVUL-2 flammability chamber.

The copper peel strength is determined by IPC test method 650-2.4.8C using IMASS SP-2000 slip peel tested.

Water Uptake is determined by IPC method 650-2,6,16 using model 8100 Autoclave @ 15 psi and an analytical balance.

Solder Dip is determined by IPC test method 650-2.6.16 using a solder bath with Tin Silver Copper Alloy.

Prepreg gel time is determined by IPC test method 650-2.3.40 using Tetrahedron Silver Copper Alloy hot plate set at 340° C.

The resin content was determined by TPC test method 650-2.3.16.1C.

### Example 1

The boric acid example was prepared from DER™ 593 using appropriate mix ratios of DER™ 592A80, Dowanol PM, boric acid in methanol (BAM), and methanol (6167 g). The mixture was then added to a dicyanamide solution (10 wt % in 50/50 Dowanol™ PM and dimethyl formamide, 1480 g) and mixed on a shaker or with a mixing blade for 15 minutes. To this solution, 2 methyl imidazole (20 wt % solution in Dowanol PM, 86.14 g) was added and the allowed to mix for 1 hour at ambient temperature. The varnish can be used as is for further testing. This varnish prepared from this example was tested for a variety of laminate qualities and is shown as the control shown in Table 1.

### Example 2

The trimethyl borate example was prepared from D.E.R.™ 593 using appropriate mix ratios of DER 592A80, Dowanol PM, and neat trimethyl borate (4612 g). The mixture was then added to a dicyanamide solution (10 wt % in 50/50 Dowanol PM and dimethyl formamide, 1107 g) and mixed on a shaker or with a mixing blade for 15 minutes. To this solution, 2 methyl imidazole (20 wt % solution in Dowanol PM, 64.6 g) was added and the mixture was allowed to mix for 1 hour at ambient temperature. The varnish can be used as is for further testing. The varnish prepared from this example was tested for a variety of laminate qualities and is shown as the control in Table 1.

TABLE 1

| | 593/Dicy/Boric Acid | 593/Dicy/ |
|---|---|---|
| | (Control) | Trimethylborate |
| Laminate Thickness | 1.40-1.50 | 1.42-1.50 |
| (mm) | | |
| Tg (° C.) | 173 | 173 |
| Td (5% wt loss, ° C.) | 297 | 296 |
| % Resin | 45 | 47 |
| T-260 (min) | 6.5 | 6.6 |
| UL-94 Rating | V-0 | V-0 |
| Cu Peel (lb/in) | 10.5 | 10.3 |
| Water Uptake (%) | 0.42 | 0.40 |
| Solder Dip @ 550 F. (% | 100 | 100 |
| Pass) | | |
| Prepreg Gel Time (s) | 96 | 100 |
| Appearance | Good | Good |

As is evident from Table I, the composition containing trimethyl borate (TMB) has qualities similar to a composition containing boric acid (BAM). There is no difference within experimental error between the two systems.

### Example 3

Sample formulations were prepared by adding methanol and Dowanol™ PM to DER™ 592 epoxy resin. BAM and TMB were then added, respectively, to the samples whilst maintaining the same solvent levels and mix ratios. The resin mixtures were then thoroughly mixed on a shaker for 1 h at ambient conditions. Dowanol™ PM was used to solubilize the mixtures. These samples were used for contact angle and surface energy measurements.

### Surface Tension and Contact Angles of BAM/TMB-Containing Samples

Surface tension and contact angle measurements were performed using a Cahn dynamic contact angle analyzer (DCA). The DCA calculates the contact angle by monitoring the change in force when one body comes into contact with another. A microscope cover glass 24 mm×30 mm×0.16 mm was accurately measured and attached to the instrument. A 60 mm diameter by 15 mm deep glass dish was filled to a depth of about 6-8 mm with sample solution. The stage was raised until the cover glass was about 3 mm above the sample solution. The test program was then started and the cover glass was slowly lowered into the glass dish. Data collection started when the solution surface came into contact with the glass slide. The test then progressed up another 2 mm and then withdrew at a rate of 25 microns per second. The surface tension determined during the withdrawal of the slide from the solution best captures the surface tension of the liquid. This process was repeated at for at least 2 samples, with a new solution. The average surface tension was determined.

TABLE 2
Surface Tension for 40% Solids Level

| | Boron | | Surface Tension |
|---|---|---|---|
| Resin | Component | Solids level (%) | (dynes/cm) |
| D.E.R. ™592 | None | Solvent only | 24.71 |
| D.E.R. ™592 | Boric Acid | 40 | 27.48 |
| D.E.R. ™592 | Trimethyl Borate | 40 | 26.97 |

DER 592™ (BA) and DER™ 592 (TMB) were both prepared at 40% solids with the components described above. Surface tension analysis was performed according to the typical test procedure described above for at least 2 samples. The surface tension results are shown in Table 2 showing a surface tension of 27.48 (dynes/cm) for boric acid containing materials and 26.97 (dynes/cm) for TMB containing materials. These differences are insignificant.

### Example 4

D.E.R. 592 with boric acid (BAM) and D.E.R. 592 with trimethyl borate (TMB) were both prepared at 45% solids with the components described in example 3 above. Surface tension analysis was performed according to the typical test procedure described above for at least 2 samples. The surface tension results are shown in Table 3 showing a surface tension of 28.13 (dynes/cm) for BAM containing materials and 28.0 (dynes/cm) for TMB containing materials. These differences are insignificant.

TABLE 3
Surface Tension for 45% Solids Level

| | Boron | | Surface Tension |
|---|---|---|---|
| Resin | Component | Solids level (%) | (dynes/cm) |
| D.E.R. ™592 | None | Solvent only | 24.71 |
| D.E.R. ™592 | Boric Acid | 45 | 28.13 |
| D.E.R. ™592 | Trimethyl Borate | 45 | 28.00 |

### Example 5

D.E.R.™ 592 with boric acid (BAM) and D.E.R.™ 592 with trimethyl borate (TMB) were both prepared at 50% solids with the components described in example 3 above. Surface tension analysis was performed according to the typical test procedure described above for at least 2 samples. The surface tension results are shown in Table 4 showing a surface tension of 28.21 (dynes/cm) for boric acid containing materials and 28.0 (dynes/cm) for TMB containing materials. These differences are insignificant.

TABLE 4
Surface Tension for 50% Solids Level

| | | | Surface Tension |
|---|---|---|---|
| Resin | Boron Component | Solids level (%) | (dynes/cm) |
| D.E.R. ™592 | None | Solvent only | 24.71 |
| D.E.R. ™592 | Boric Acid | 50 | 28.21 |
| D.E.R. ™592 | Trimethyl Borate | 50 | 28.00 |

Surface Tension Measurement with Different Boric Acid and TMB Levels

Varying amounts of boron content based on the original formulation was studied. For the original surface tension measurements the amount of boron was kept at 0.418% solids with boric acid and 0.701% with trimethyl borate.

D.E.R. 592 (BAM) and D.E.R. 592 (TMB) samples were both prepared as described in example 2 at 50% solids. The boron level was adjusted for each experiment and surface tension analyses were completed as described above for at least 2 samples. The surface tension results are shown in Table 5 of boric acid and TMB containing resins at a variety of loading levels to be relatively similar.

TABLE 5
Effect of Surface tension based on boron content

| | | | Boron Component | Surface |
|---|---|---|---|---|
| | | Boron | Content (% based | Tension |
| Resin | % solids | Component | on solids) | (dynes/cm) |
| D.E.R. ™592 | 50 | none | 0.00 | 27.83 |
| D.E.R. ™592 | 50 | BAM | 0.20 | 28.19 |
| D.E.R. ™592 | 50 | BAM | 0.41 | 28.21 |
| D.E.R. ™592 | 50 | BAM | 0.82 | 28.31 |
| D.E.R. ™592 | 50 | TMB | 0.35 | 27.93 |
| D.E.R. ™592 | 50 | TMB | 0.70 | 28.00 |
| D.E.R. ™592 | 50 | TMB | 1.40 | 27.98 |

That which is claimed is:

1. A composition comprising:
a) a polyepoxide;
b) a hardener;
c) trimethyl borate; and
d) a flame retardant.

2. A composition in accordance with claim 1 wherein said trimethyl borate is not dispersed in a solvent before becoming part of said composition.

3. A composition in accordance with claim 1 wherein said polyepoxide is also a flame retardant comprising elements selected from the group consisting of bromine, phosphorus, nitrogen, boron, and silicon.

4. A composition in accordance with claim 1 wherein said composition has a solids content in the range of from about 76 weight percent to about 79 weight percent.

5. A composition in accordance with claim 1 wherein said polyepoxide contains a derivative of tetrabromobisphenol A.

6. A composition in accordance with claim 1 wherein said polyepoxide is a condensation product of an epoxy novolac with DOPO (6H-dibenz[c,e][1,2]oxaphosphorin, 6-oxide).

7. A reactive mixture comprising:
(a) a composition of claim 1; and
(b) an epoxy resin catalyst. and
(c) optionally an epoxy resin curing agent.

8. A composition in accordance with claim 7 wherein the gel time measured at 140° C. is increased by at least 10% when compared with the same formulation that does not contain (ii) a trialkyl borate.

9. A composition in accordance with claim 7 wherein the glass transition temperature after full cure is increased by at least 5° C. when compared with the same formulation that does not contain (ii) a trialkyl borate.

10. A composition in accordance with claim 6 further comprising: (d) a fibrous reinforcement.

11. A varnish produced from the composition of claim 1.

12. A prepreg prepared from the varnish of claim 11.

13. An electrical laminate prepared from the varnish of claim 11.

14. A printed circuit board prepared from the varnish of claim 11.

15. A coating prepared from the varnish of claim 11.

16. A composite prepared from the varnish of claim 11.

17. A casting prepared from the varnish of claim 11.

18. An adhesive prepared from the varnish of claim 11.
